(19) United States
(12) Patent Application Publication
(10) Pub. No.: US 2024/0094380 A1
(43) Pub. Date: Mar. 21, 2024

(54) METHOD FOR PERFORMING POSITIONING OPERATION AND ELECTRONIC DEVICE FOR SUPPORTING SAME

(71) Applicant: Samsung Electronics Co., Ltd., Suwon-si (KR)

(72) Inventors: Youngsuk YOO, Suwon-si (KR); Woosup LEE, Suwon-si (KR); Sukgi HONG, Suwon-si (KR)

(21) Appl. No.: 18/523,117

(22) Filed: Nov. 29, 2023

Related U.S. Application Data
(63) Continuation of application No. PCT/KR2022/009537, filed on Jul. 1, 2022.

(30) Foreign Application Priority Data
Jul. 6, 2021 (KR) 10-2021-0088536

(51) Int. Cl. G01S 13/76

(52) U.S. Cl. CPC G01S 13/765

(57) ABSTRACT

An electronic device that performs a positioning operation is disclosed. The electronic device may comprise: a wireless communication circuit, at least one processor, and a memory. The electronic device may be configured to: transmit a first positioning signal to a first external electronic device by the wireless communication circuit; receive, from the first external electronic device, a first response signal corresponding to the first positioning signal; identify a first separation distance and an angle of arrival based on the first response signal; transmit, based on determining that the first separation distance exceeds a specified value, a second positioning signal to a second external electronic device; receive, from the second external electronic device, a second response signal corresponding to the second positioning signal; identify a second separation distance based on the second response signal; and determine that the first external electronic device is located in a first radial area corresponding to the first separation distance, a second radial area corresponding to the second separation distance, and an overlapping area of an area corresponding to the angle of arrival.

### CROSS-REFERENCE TO RELATED APPLICATIONS

This application is a continuation of International Application No. PCT/KR2022/009537 designating the United States, filed on Jul. 1, 2022, in the Korean Intellectual Property Receiving Office and claiming priority to Korean Patent Application No. 10-2021-0088536, filed on Jul. 6, 2021, in the Korean Intellectual Property Office, the disclosures of each of which are incorporated by reference herein in their entireties.

### BACKGROUND

### Field

The disclosure relates to a method for performing a positioning operation and an electronic device supporting the same.

### Description of Related Art

With the development of mobile communication technology, electronic devices having at least one antenna are widely disseminated. Electronic devices may transmit/receive radio frequency (RF) signals including a voice signal or data (e.g., message, image, video, music file, or game) using an antenna.

An antenna may simultaneously transmit/receive signals belonging to different frequency bands using a plurality of frequency bands. Electronic devices may provide a service of a global communication band using signals belonging to different frequency bands. For example, electronic devices may perform communication (e.g., GPS, Legacy, WiFil) using a signal belonging to a low frequency band (LB) and/or communication (e.g., WiFi2) using a high frequency band (HB).

Meanwhile, electronic devices may perform positioning based on an ultra-wideband (UWB) signal. For example, a UWB signal may have a frequency band of at least 500 MHz. Since an ultra-wideband signal has characteristics similar to those of an impulse signal, a pulse width is shorter than a path delay. Therefore, in positioning using a UWB signal, a direct signal and a reflected signal may be easily differentiated. Electronic devices may relatively accurately perform positioning (e.g., error of less than 30 cm) using at least one antenna based on the above-mentioned characteristics of a UWB signal.

Electronic devices may perform positioning based on various positioning algorithms (e.g., angle of arrival (AoA), time difference of arrival (TDoA), time difference of arrival (AoD), time of arrival (ToA), time of flight (ToF), and/or two way ranging (TWR)).

There is a problem that the accuracy of positioning deteriorates as an external electronic device that transmits and/or receives a signal is located at a farther distance during a process in which an electronic device performs a positioning function based on various positioning algorithms (e.g., AOA). Furthermore, there is a problem that it is difficult to accurately identify where an external electronic device is present using only the prior art when identifying the external electronic device by performing a positioning function using only one electronic device.

In particular, when an external electronic device is present at a distance exceeding a specified distance from an electronic device, the coverage and/or accuracy of location measurement deteriorates. Moreover, distance information that can be obtained by performing a positioning function according to the prior art only enables identification of information indicating the presence of an external electronic device within a certain range, and there is a limitation in obtaining direction information about the location of the external electronic device.

### SUMMARY

Embodiments of the disclosure may provide a positioning operation performing method capable of more accurately identifying location information of an external electronic device that is a target of location identification by performing a positioning function using a plurality of electronic devices, and an electronic device supporting the same.

An electronic device according to an example embodiment of the present disclosure may include: a wireless communication circuit, at least one processor, and a memory. The memory may store instructions that, when executed by one or more of the at least one processor, cause the electronic device to: transmit a first positioning signal to a first external electronic device and receive a first response signal corresponding to the first positioning signal from the first external electronic device using the wireless communication circuit; identify a first separation distance between the electronic device and the first external electronic device and an angle of arrival between the electronic device and the first external electronic device based on the received first response signal; based on the first separation distance being determined to exceed a specified value, transmit a second positioning signal to a second external electronic device and receive a second response signal corresponding to the second positioning signal from the second external electronic device; identify a second separation distance between the first external electronic device and the second external electronic device based on the received second response signal; and determine that the first external electronic device is located within an overlapping region among a first radius region corresponding to the first separation distance, a second radius region corresponding to the second separation distance, and a region corresponding to the angle of arrival.

A method for operating an electronic device to perform a positioning operation according to an example embodiment of the present disclosure may include: transmitting a first positioning signal to a first external electronic device and receiving a first response signal corresponding to the first positioning signal from the first external electronic device; identifying a first separation distance between the electronic device and the first external electronic device and an angle of arrival between the electronic device and the first external electronic device based on the received first response signal; based on the first separation distance being determined to exceed a specified value, transmitting a second positioning signal to a second external electronic device; receiving a second response signal corresponding to the second positioning signal from the second external electronic device; identifying a second separation distance between the first external electronic device and the second external electronic device based on the received second response signal; and determining that the first external electronic device is located within an overlapping region among a first radius region corresponding to the first separation distance, a second radius region corresponding to the second separation distance, and a region corresponding to the angle of arrival.

According to various example embodiments of the present disclosure, with regard to an electronic device that performs ultra-wideband communication, deterioration of the performance of location measurement due to various constraints may be prevented and/or reduced when the electronic device performs a positioning operation using a plurality of electronic devices.

According to various example embodiments of the present disclosure, more specific and accurate location information may be identified by performing a positioning operation using a plurality of electronic devices.

According to various example embodiments of the present disclosure, positioning information may be provided to a user efficiently and immediately by performing a positioning function by flexibly using a wearable device owned by a user or an electronic device of an external user.

Besides, various effects may be provided that are directly or indirectly identified through the present disclosure.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a block diagram illustrating an example electronic device in a network environment according to various embodiments;

FIG. 2 is a block diagram illustrating an example configuration of an electronic device according to various embodiments;

FIG. 3A is a block diagram illustrating an example configuration of an electronic device according to various embodiments;

FIG. 3B is a signal flow diagram illustrating an example method for an electronic device to measure a distance to an external electronic device according to Various embodiments;

FIG. 4 is a diagram illustrating an example method for an electronic device to measure an angle of arrival with an external electronic device according to various embodiments;

FIG. 5 is a diagram illustrating an example process of a positioning function performed using a plurality of antennas according to various embodiments;

FIG. 6 is a signal flow diagram illustrating an example positioning function performed by an electronic device with a plurality of external electronic devices according to various embodiments;

FIG. 7 is a diagram illustrating an example positioning function performed by an electronic device with a plurality of external electronic devices according to various embodiments;

FIG. 8 is a diagram illustrating an example positioning function performed by an electronic device with a plurality of external electronic devices according to various embodiments;

FIG. 9 is a diagram illustrating an example user interface displayed on a display by an electronic device according to various embodiments;

FIG. 10 is a diagram illustrating an example user interface displayed on a display by an electronic device according to various embodiments;

FIG. 11 is a diagram illustrating an example user interface displayed on a display by an electronic device according to various embodiments;

FIG. 12 is a diagram illustrating an example user interface displayed on a display by an electronic device according to various embodiments;

FIG. 13 is a flowchart illustrating an example operation of an electronic device according to various embodiments; and

FIG. 14 is a flowchart illustrating an example operation of an electronic device according to various embodiments.

With respect to the description of the drawings, the same or similar reference numerals may be used for the same or similar elements.

### DETAILED DESCRIPTION

Hereinafter, various example embodiments of the present disclosure will be described in greater detail with reference to the accompanying drawings. However, it should be understood that the present disclosure is not limited to specific embodiments, but rather includes various modifications, equivalents and/or alternatives of the various embodiments of the present disclosure.

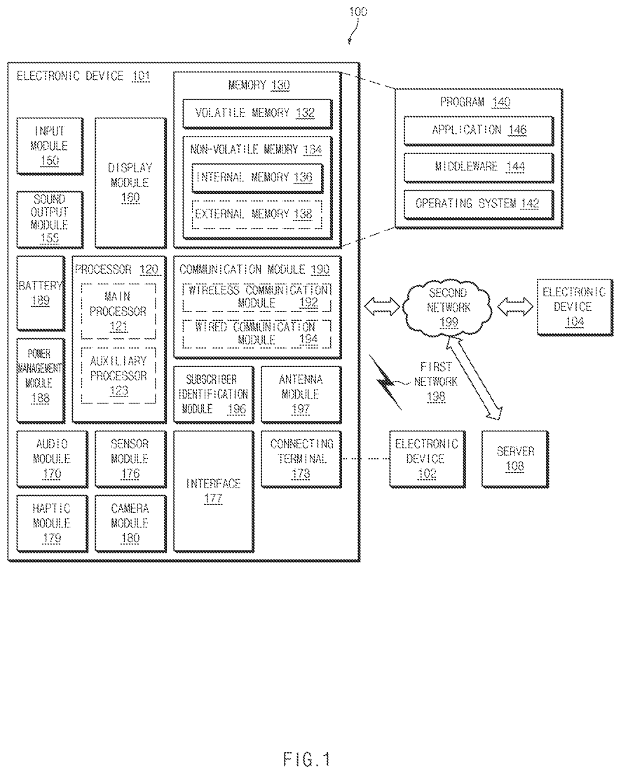

FIG. 1 is a block diagram illustrating an example electronic device 101 in a network environment 100 according to various embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In various embodiments, at least one of the components (e.g., the connecting terminal 178) may be omitted from the electronic device 101, or one or more other components may be added in the electronic device 101. In various embodiments, some of the components (e.g., the sensor module 176, the camera module 180, or the antenna module 197) may be implemented as a single component (e.g., the display module 160).

The processor 120 may include various processing circuitry (as used herein, including the claims, the term “processor” may include various processing circuitry, including at least one processor, wherein one or more of the at least one processor may be configured to perform the various functions described herein) and execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of lms or less) for implementing URLLC.

The antenna module 197 may transmit and/or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used in connection with various embodiments of the disclosure, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

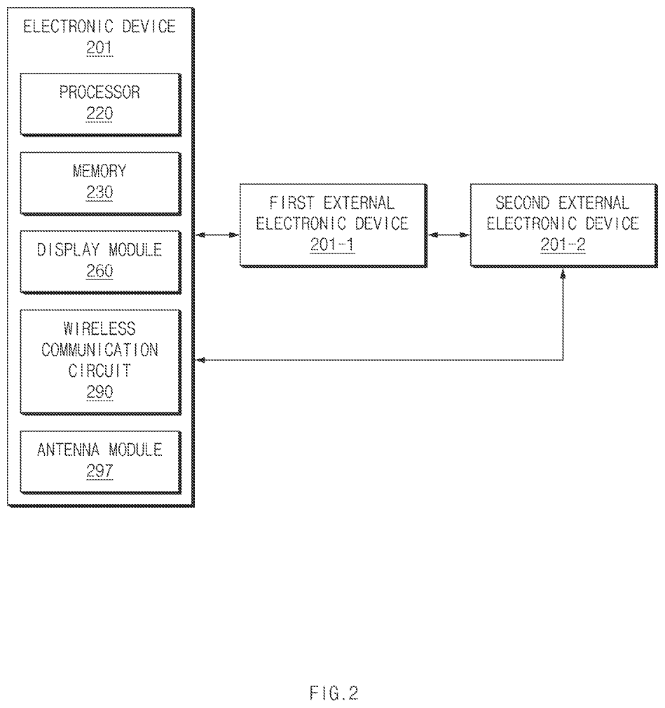

FIG. 2 is a block diagram illustrating an example configuration of an electronic device 201 according to various embodiments.

Referring to FIG. 2, the electronic device 201 (e.g., the electronic device 101 of FIG. 1) may include a processor (e.g., including processing circuitry) 220 (e.g., the processor 120 of FIG. 1), a memory 230 (e.g., the memory 130 of FIG. 1), a display module (e.g., including a display) 260 (e.g., the display module 160 of FIG. 1), a wireless communication circuit 290 (e.g., the communication module 190 of FIG. 1), and an antenna module (e.g., including an antenna) 297 (e.g., the antenna module 197 of FIG. 1). The processor 220 may be operatively connected to the memory 230, the display module 260, the wireless communication circuit 290, and/or the antenna module 297. The configuration of the electronic device 201 illustrated in FIG. 2 is merely a non-limiting example, and embodiments of the present disclosure are not limited thereto. For example, the electronic device 201 may further include a component not illustrated in FIG. 2 (e.g., the sensor module 176, the interface 177, and/or the camera module 180 of FIG. 1).

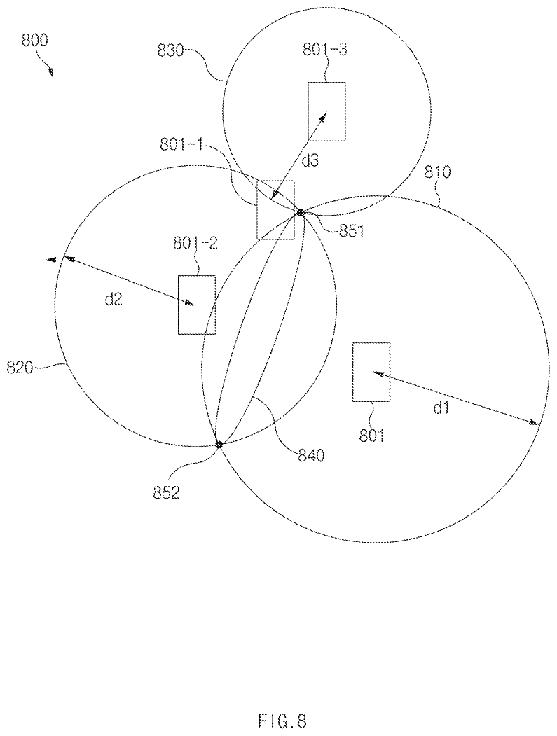

According to an embodiment, a first external electronic device 201-1 and a second external electronic device 201-2 may be referred to as separate electronic devices that perform wireless communication with the electronic device 201 and are physically spaced apart from the electronic device 201. Some or all of operations performed in the first external electronic device 201-1 and the second external electronic device 201-2 may be performed in the electronic device 201. For example, the first external electronic device 201-1 and the second external electronic device 201-2 may include a wearable device such as a smart watch, headphones, and/or earbuds, a laptop computer, a tablet computer, a mobile phone, or a vehicle capable of wireless communication, but are not limited to the above examples. Although FIG. 2 illustrates two external electronic devices performing wireless communication with the electronic device 201, this is merely illustrative and embodiments of the present disclosure are not limited thereto. For example, at least one external electronic device (e.g., the third external electronic device of FIG. 8) may further perform wireless communication with the electronic device 201. For example, the electronic device 201, the first external electronic device 201-1, and the second external electronic device 201-2 may be electronic devices owned by the same user. The first external electronic device 201-1 and the second external electronic device 201-2 may be referred to as electronic devices that include the same account information or belong to the same group as the electronic device 201. The same account information may include the same identifier (e.g., synced identifier), a Bluetooth address of the same representative device (e.g., the electronic device 201), or the same account information-based value (e.g., hash value). For another example, at least one of the first external electronic device 201-1 or the second external electronic device 201-2 may not include the same account information as the electronic device 201. For example, the second external electronic device 201-2 may be an electronic device owned by a user different from the user of the electronic device 201.

According to an example, the processor 220 (e.g., the processor 120 of FIG. 1) may include various processing circuitry (as used herein, including the claims, the term “processor” may include various processing circuitry, including at least one processor, wherein one or more of the at least one processor may be configured to perform the various functions described herein) and may be referred to as a component for processing various processes executed in the electronic device 201. The processor 220 may be electrically or operatively coupled (or connected) with the other components (e.g., the memory 230, the display module 260, the wireless communication circuit 290, and/or the antenna module 297) of the electronic device 201, and may be configured to control the other components of the electronic device 201. For example, the processor 220 may transmit/receive various data and/or signals (e.g., positioning signal) to/from the first external electronic device 201-1 and/or the second external electronic device 201-2 using the wireless communication circuit 290. For example, the electronic device 201 may transmit a first positioning signal to the first external electronic device 201-1 and receive a first response signal from the first external electronic device 201-1. The first response signal may be referred to as an electric signal generated by the first external electronic device 201-1 in response to the first positioning signal received from the electronic device 201. For another example, the electronic device 201 may transmit a second positioning signal to the second external electronic device 201-2 and receive a second response signal from the second external electronic device 201-2. The second response signal may be referred to as an electric signal generated by the second external electronic device 201-2 in response to the second positioning signal received from the electronic device 201. For example, the second response signal may include location information (e.g., angle of arrival or separation distance) of the first external electronic device 201-1 and the second external electronic device 201-2 and/or location information (e.g., angle of arrival or separation distance) of the electronic device 201 and the second external electronic device 201-2. The processor 220 may calculate and/or identify an angle of arrival and/or a separation distance between the electronic device 201 and external electronic devices based on signals received from the external electronic devices. For example, the processor 220 may calculate and/or identify an angle of arrival and/or a separation distance (e.g., first separation distance) with respect to the first external electronic device 201-1 based on the first response signal. For another example, the processor 220 may calculate and/or identify an angle of arrival and/or a separation distance (e.g., second separation distance) between the first external electronic device 201-1 and the second external electronic device 201-2 based on the second response signal. For another example, the processor 220 may calculate and/or identify an angle of arrival and/or a separation distance between the electronic device 201 and the second external electronic device 201-2 based on the second response signal.

According to an embodiment, the memory 230 (e.g., the memory 130 of FIG. 1) may store commands or data. For example, the memory 230 may store one or more instructions that, when executed by the processor 220, cause the electronic device 201 to perform various operations. For another example, the memory 230 may store information associated with a plurality of functions provided by the electronic device 201. For example, the memory 230 may store location information of the electronic device 201 and external electronic devices (e.g., the first external electronic device 201-1 and/or the second external electronic device 201-2).

According to an embodiment, the display module 260 (e.g., the display module 160 of FIG. 1) may include a display and display various user interfaces. For example, the display module 260 may display a user interface for allowing the electronic device 201 to provide a function of searching for a location of at least one (e.g., the first external electronic device 201-1) of external electronic devices (e.g., the first external electronic device 201-1 and/or the second external electronic device 201-2). For example, the user interface may include at least one graphic user interface (GUI) for starting a function of searching for a location in response to a specified input. The specified input may be referred to as a user's touch input to at least one GUI or one region of the user interface. For example, when location information of at least one (e.g., the first external electronic device 201-1) of external electronic devices is identified, the display module 260 may display information associated with a direction toward a region in which the first external electronic device 201-1 is determined to be located with respect to the electronic device 201 and/or guide information associated with the direction.

According to an embodiment, the wireless communication circuit 290 (e.g., the communication module 190 of FIG. 1) may support establishment of a communication channel (e.g., wireless communication channel) between the electronic device 201 and external electronic devices (e.g., the first external electronic device 201-1 and/or the second external electronic device 201-2) and execution of communication through the established communication channel. For example, the wireless communication circuit 290 may include a Bluetooth communication module and/or an ultra wideband (UWB) communication module including various communication circuitry. The electronic device 201 may transmit and/or receive various electric signals to/from external electronic devices through the wireless communication circuit based on Bluetooth communication and/or UWB communication. For example, the electronic device 201 may transmit a first positioning signal to the first external electronic device 201-1 and transmit a second positioning signal to the second external electronic device 201-2 based on a UWB protocol. For another example, the electronic device 201 may receive a second response signal corresponding to the second positioning signal from the second external electronic device 201-2 based on a Bluetooth protocol.

According to an embodiment, the antenna module 297 (e.g., the antenna module 197 of FIG. 1) may include at least one antenna and transmit and/or receive a signal or power to or from the outside (e.g., the first external electronic device 201-1 and/or the second external electronic device 201-2). For example, the antenna module 297 may transmit and/or receive an RF signal of a specified band. The RF signal of a specified band may include, for example, a UWB signal transferred in a UWB frequency band (e.g., frequency band having a center frequency of 6 GHz or 8 GHz). The UWB signal may be based on an impulse radio scheme. The UWB signal may have a specified bandwidth, for example, 499 MHz bandwidth or at least 500 MHz bandwidth, but embodiments of the present disclosure are not limited thereto. For example, the processor 220 may calculate and/or identify the location of an external electronic device (e.g., the first external electronic device 201-1 and/or the second external electronic device 201-2) based on an RF signal transmitted/received using the antenna module 297.

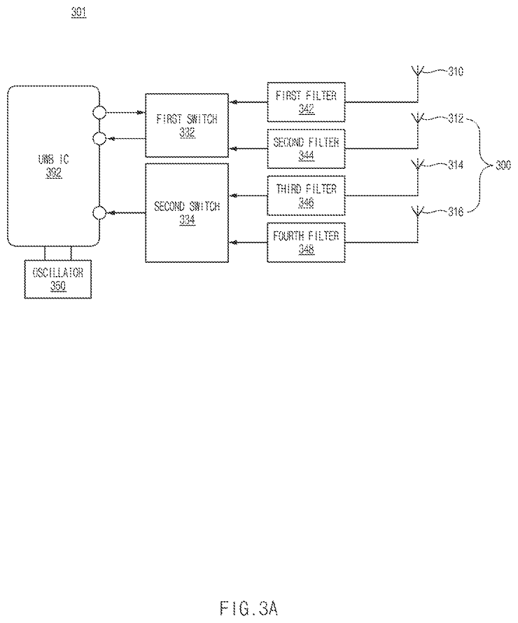

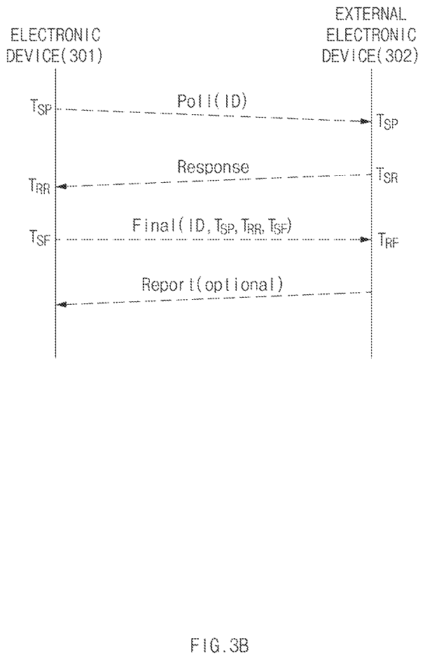

Hereinafter, an example method for the electronic device 201 to detect the location of an external electronic device (e.g., the first external electronic device 201-1) will be described in greater detail below with reference to FIGS. 3A, 3B, 4, and 5.

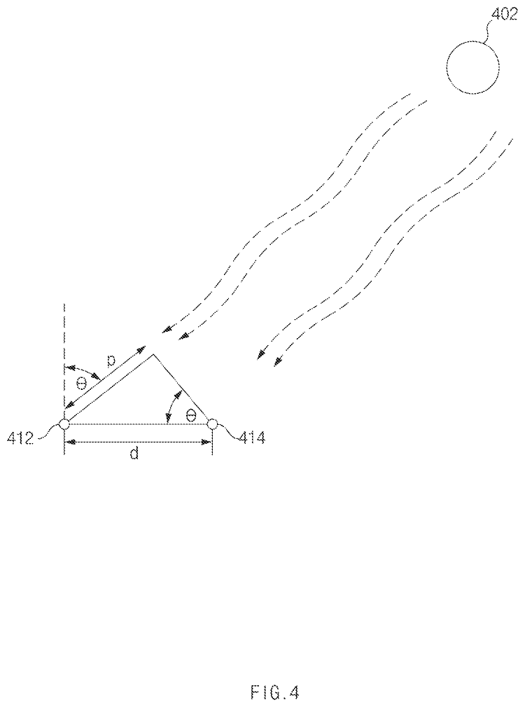

Referring to FIGS. 3A, 3B, and 4, according to an embodiment, an electronic device 301 may measure a distance between the electronic device 301 and an external electronic device 302 based on an RF signal transmitted and/or received from the external electronic device 302 (e.g., the first external electronic device 201-1 and/or the second external electronic device 201-2 of FIG. 2).

Referring to FIG. 3A, the electronic device 301 (e.g., the electronic device 101 of FIG. 1) according to an embodiment may include a plurality of antennas (e.g., a first antenna 310, a second antenna 300), a first switch 332, a second switch 334, a first filter 342, a second filter 344, a third filter 346, a fourth filter 348, an oscillator 350, and a UWB IC (e.g., a UWB integrated circuit) 392.

In an embodiment, the first antenna 310 may be connected to the first filter 342. In an embodiment, the first filter 342 may filter a signal transmitted or received from the first antenna 310 using a frequency of a specified band as a passband. In an embodiment, the first filter 342 may be connected to the first switch 332, and the first switch 332 may be connected to the UWB IC 392. In an embodiment, the first switch 332 may include a double pole double throw (DPDT) switch.

In an embodiment, the second antenna 300 may include, as radiating elements, a first conductive patch 312, a second conductive patch 314, and a third conductive patch 316.

In an embodiment, the first conductive patch 312 may be connected to the second filter 344, and the second filter 344 may be connected to the first switch 332. In an embodiment, the second filter 344 may filter a signal transmitted or received from the first conductive patch 312 using a frequency of a first specified band as a passband. In an embodiment, the first antenna 310 or the first conductive patch 312 may be selectively connected to a TX1 port or RX2 port of the UWB IC 392 via the first switch 332 In an embodiment, the first switch 332 may be controlled by the UWB IC 392

In an embodiment, the second conductive patch 314 may be connected to the third filter 346, and the third filter 346 may be connected to the second switch 334. In an embodiment, the third filter 346 may filter a signal transmitted or received from the second conductive patch 314 using the frequency of the first specified band as a passband.

In an embodiment, the third conductive patch 316 may be connected to the fourth filter 348, and the fourth filter 348 may be connected to the second switch 334. In an embodiment, the fourth filter 348 may filter a signal transmitted or received from the third conductive patch 316 using the frequency of the first specified band as a passband.

In an embodiment, the second switch 334 may be connected to the UWB IC 392. In an embodiment, the second switch 334 may include a single pole double throw (SPDT) switch. In an embodiment, the second conductive patch 314 or the third conductive patch 316 may be selectively connected to an RX1 port of the UWB IC 392 via the second switch 334. In an embodiment, the second switch 334 may be controlled by the UWB IC 392.

In an embodiment, the oscillator 350 may be connected to the UWB IC 392. In an embodiment, the UWB IC 392 may generate a UWB signal based on a signal provided from the oscillator 350.

In an embodiment, the UWB IC 392 (e.g., the first communication module 190 of FIG. 1 or the wireless communication circuit 290 of FIG. 2) may transmit and/or receive an RF signal of the first specified band. For example, the UWB IC 392 may transmit the RF signal of the first specified band using the first antenna 310. For example, the UWB IC 392 may transmit and/or receive the RF signal of the first specified band using the first conductive patch 312 of the second antenna 300. For example, the UWB IC 392 may receive the RF signal of the first specified band using the second conductive patch 314 or third conductive patch 316 of the second antenna 300. The RF signal of the first specified band may include, for example, a UWB signal transferred in a UWB frequency band (e.g., frequency band having a center frequency of 6 GHz or 8 GHz). The UWB signal may be based on an impulse radio scheme. The UWB signal may have a specified bandwidth, for example, 499 MHz bandwidth or at least 500 MHz bandwidth. However, embodiments are not limited thereto. In an embodiment, the first antenna 510 may be an antenna for ranging an external device, and the second antenna 500 may be an antenna for measuring an angle of arrival of an RF signal received from an external device.

In an embodiment, the UWB IC 392 may include processing circuitry for controlling at least some (e.g., the first antenna 310, the second antenna 300, the first switch 332, and the second switch) of the components illustrated in FIG. 3A. The processing circuitry may include at least one processor as noted above. In an embodiment, at least a portion of the UWB IC 392 may be integrated with the processor 120 of FIG. 1. In this case, the processor 120 may perform at least some of functions of the UWB IC 392.

In an embodiment, some of the components illustrated in FIG. 3A may be integrated with the UWB IC 392. For example, at least one of the first switch 332, the second switch 334, the first filter 342, the second filter 344, the third filter 346, the fourth filter 348, and/or the oscillator 350 may be integrated with the UWB IC 392. In this case, the UWB IC 392 may perform a function of at least one of the first switch 332, the second switch 334, the first filter 342, the second filter 344, the third filter 346, the fourth filter 348, and/or the oscillator 350 in substantially the same manner.

In an embodiment, the UWB IC 392 may detect the location of an external electronic device based on an RF signal transmitted/received using the first antenna 310 and the second antenna 300. The external electronic device may include, for example, various devices capable of wireless communication. For example, the external electronic device may include a laptop computer, a tablet computer, a mobile phone, a wearable device such as an electronic watch, headphones, and earbuds, or a vehicle capable of wireless communication, but are not limited to the above examples.

Hereinafter, an example method for the electronic device 301 to identify the location of an external electronic device (e.g., the first external electronic device 201-1 of FIG. 2) will be described in greater detail below with reference to FIGS. 3B, 4, 5, and 6.

Referring to FIGS. 3B and 4, the UWB IC 392 according to an embodiment may measure a distance between the electronic device 301 and the external electronic device 302 based on an RF signal transmitted/received from the external electronic device 302. For example, the electronic device 301 or the UWB IC 392 may transmit/receive a message including time stamp information to/from the external electronic device 302. For example, the electronic device 301 may transmit at least one request message (e.g., first positioning signal and/or second positioning signal) including information about an identifier (ID) and transmission time T_{SP} to the external electronic device 302 using an antenna module (e.g., the first antenna module 197 of FIG. 1). In response to reception of the at least one request message, the external electronic device 302 may transmit at least one response message (e.g., first response signal and/or second response signal) to the electronic device 301. The electronic device 301 may receive the at least one response message using at least some (e.g., the first antenna 310 and/or the second antenna 300) of the components included in the antenna module. The at least one response message may include a time T_{RP} at which the at least one request message (poll) was received and a time T_{SR} at which the at least one response message was transmitted. The electronic device 301 and/or the UWB IC 392 may determine a time (round trip time (RTT)) taken to receive the at least one response message after transmitting the at least one request message (e.g., T_{RR}−T_{SP}). The electronic device 301 and/or the UWB IC 392 may determine a reply time taken for the external electronic device 302 to transmit the response message after receiving the at least one request message (e.g., T_{SR}−T_{RP}). The electronic device 301 may determine a time of flight (TOF) that is a time taken for radio waves to be transmitted from the electronic device 301 and arrive at the external electronic device 302, based on the RTT and the reply time (e.g., (RTT-reply time)÷2=(T_{RR}−T_{SP}−T_{SR}+T_{RP})÷2). The electronic device 301 and/or the UWB IC 392 may measure a distance between the electronic device 301 and the external electronic device 302 based on the TOF (e.g., TOF×speed of radio wave).

FIG. 4 is a diagram illustrating an example method of operating an electronic device (e.g., the electronic device 101 of FIG. 1) to measure an angle of arrival with an external electronic device 402 according to various embodiments.

In an embodiment, the electronic device and/or the UWB IC 392 may measure an angle of arrival (AoA) of an RF signal received from the external electronic device 402 using at least one antenna (e.g., the second antenna 300). For example, the electronic device may determine an angle of arrival of a signal received from the external electronic device 402 based on a phase difference of arrival (PDOA) between RF signals respectively received by a plurality of antenna elements (e.g., the first conductive patch 312 and the second conductive patch 314) included in the antenna module, wavelengths of the received RF signals, and a distance between the plurality of antenna elements. For example, the angle of arrival may be determined using Equation 1 to Equation 4 below.

p=d sin(θ) [Equation 1]

In Equation 1, p may denote a difference of path length between the RF signals respectively received by the plurality of antenna elements. In Equation 1, d may denote a physical distance between the plurality of antenna elements. In Equation 1, θ may denote an angle of arrival of an RF signal received from the external electronic device 402.

The wavelengths of the RF signals received by the plurality of antenna elements may be expressed as Equation 2 below.

$$λ = \frac{2 π c}{f} \qquad [ Equation 2 ]$$

In Equation 2, λ may denote the wavelength of the RF signal, f may denote the frequency of the RF signal, and c may denote the speed of light that is the speed of radio waves in free space (air).

The phase difference of arrival between the RF signals respectively received by the plurality of antenna elements is expressed as Equation 3 using Equation 2 and the path length difference p.

$$a = \frac{2 π}{λ} p = \frac{f}{c} p \qquad [ Equation 3 ]$$

In Equation 3, α may denote the phase difference of arrival of the RF signals received by the plurality of antenna elements.

The angle θ of arrival of an RF signal received from the external electronic device 402 may be expressed as Equation 4 below using Equation 1 and Equation 3.

$$⊖ = {sin}^{- 1} \frac{αλ}{2 π d} \qquad [ Equation 4 ]$$

Referring to Equation 1, in order to measure the angle of arrival of an RF signal received from the external electronic device 402 located within an angle range of −90 degrees to 90 degrees with respect to the electronic device, a distance d between a first antenna element 412 (e.g., the first conductive patch 312 of FIG. 3A) and a second antenna element 414 (e.g., the second conductive patch 314 of FIG. 3A) may be required to be equal to or less than a half (λ/2) of the wavelength of the RF signal. For example, if the distance d between the first antenna element 412 and the second antenna element 414 exceeds the half (λ/2) of the wavelength of the RF signal, the phase difference α and the angle θ of arrival may not be 1:1 mapped within a range of −90 degrees to +90 degrees. Even if the distance d between the first antenna element 412 and the second antenna element 414 is equal to or less than the half (λ/2) of the wavelength of the RF signal, the accuracy of measurement of the angle θ of arrival may decrease as the distance d between the first antenna element 412 and the second antenna element 414 decreases.

According to an embodiment, the electronic device may determine a direction (or azimuth) of the external electronic device 402 based on information about a magnetic north direction and the angle θ of arrival of an RF signal received from the external electronic device 402. The information about a magnetic north direction may be obtained using, for example, at least one sensor (e.g., the sensor module 176 of FIG. 1) such as a geomagnetic sensor of the electronic device. In an embodiment, the electronic device may determine the location of the external electronic device 402 based on the direction of the external electronic device 402 and a distance to the external electronic device 402.

However, the method of operating the electronic device to detect the location of the external electronic device 402 is not limited to the above example, and various methods usable by a person skilled in the art may be applied. Furthermore, the positioning function of the electronic device as described above may be referred to as a function performed by a UWB integrated circuitry (IC) (e.g., the UWB IC 392 of FIG. 3A) included in the electronic device.

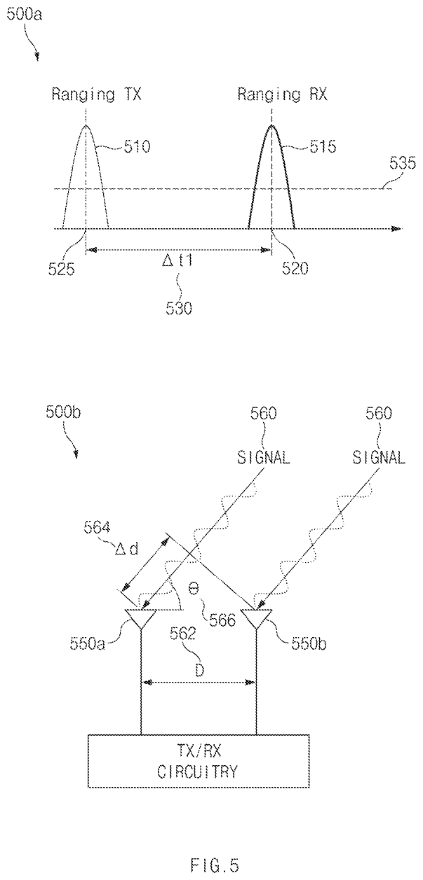

FIG. 5 is a diagram illustrating an example process of a positioning function performed using a plurality of antennas according to various embodiments.

Reference number 500a of FIG. 5 illustrates ranging by an electronic device (e.g., the electronic device 101 of FIG. 1). 500b of FIG. 5 illustrates a mode in which a plurality of antenna elements (e.g., first antenna element and second antenna element) included in the electronic device measure an angle of arrival (AoA). The ranging and AoA measurement functions of FIG. 5 may be performed by a processor (not shown) (e.g., the processor 120 of FIG. 1) of the electronic device.

Referring to reference number 500a, according to an embodiment, the processor may transmit a positioning signal 510 (e.g., poll message) using an antenna. For example, the positioning signal 510 may include information (e.g., time stamp) about a transmission time 525 of the positioning signal 510. According to an embodiment, the processor may receive a signal 515 (e.g., response message) for the positioning signal 510. For example, the signal 515 for the positioning signal 510 may represent a reflected signal of the positioning signal 510 from a positioning target or a response signal transmitted from an external object that has received the positioning signal 510. In the present disclosure, the term “signal for a positioning signal” may also be referred to as “reception signal” and/or “response signal”.

According to an embodiment, the processor may determine an arrival time 520 of the reception signal 515. For example, the processor may set a threshold 535 to find the arrival time 520 of the reception signal 515. If strength of the reception signal 515 exceeds the threshold 535, the processor may search for a first path. In detail, the processor may determine, as the first path, a peak of the strength of the reception signal 515 after the strength of the reception signal 515 exceeds the threshold 535. The processor may determine the first path of the reception signal 515 as the arrival time 520 of the reception signal 515. The processor may range a positioning target by calculating Δt1 530 that is a difference between the transmission time 525 and the arrival time 520. For example, ranging using Δt1 530 may be calculated through Equation 5 below.

Measured distance=(Δt1−delay time)*A/2 [Equation 5]

In Equation 5, the delay time may be understood as a time taken for the positioning target to receive the positioning signal 510 and transmit (or return) the signal 515 for the positioning signal 510. According to an embodiment, the reception signal 515 may include information about the delay time. In Equation 5, A may be construed as a constant related to the speed of light or the speed of radio wave propagation.

Referring to reference number 500b, the processor may use two or more antennas (e.g., a first antenna element 550a and a second antenna element 550b) in order to measure an AoA. The processor may receive a reception signal 560 (e.g., the reception signal 515 of reference number 500a) for a positioning signal using a plurality of antennas. The first antenna element 550a and the second antenna element 550b may be designed to be spaced a separation distance D 562 apart from each other. Information about the separation distance D 562 may be stored in a memory (e.g., the memory 130 of FIG. 1) of the electronic device. For example, the separation distance D 562 may represent a physical distance between geometric centers calculated based on one point corresponding to a geometric center of the first antenna element 550a and one point corresponding to a geometric center of the second antenna element 550b. For another example, the separation distance D 562 may represent an electric separation distance between antenna elements. Optimum measurement efficiency may be derived when the separation distance D 562 for AoA measurement is a half (e.g., λ/2) of a wavelength λ of a signal. For example, the electronic device may derive a most efficient AoA measurement result when the separation distance D 562 is 15 mm to 18 mm, but this is merely illustrative, and may be differently referred to according to a mounting space of the electronic device, the performance of the antenna module, etc. A time at which the first antenna element 550a receives the reception signal 560 and a time at which the second antenna element 550b receives the reception signal 560 may be different from each other due to the separation distance D 562 between the first antenna element 550a and the second antenna element 550b. The processor may measure Ad 564 using an arrival time difference of the reception signal 560 received using the first antenna element 550a and the second antenna element 550b. The separation distance D may be defined as Equation 6 using Δd 564 and AoA θ 566. A phase difference Δ_{φ} of arrival between signals received by the first antenna element 550a and the second antenna element 550b may be calculated using Δd 564 as expressed in Equation 7.

D=Δd*cos θ [Equation 6]

Δ_{φ}=2π/λ*Δd [Equation 7]

The processor may calculate AoA θ 566 using a method expressed as Equation 8 by calculating Equation 6 and Equation 7.

$$AoA ( ⊖ ) = {cos}^{- 1} ( \frac{Δ φ}{\frac{2 π D}{λ}} ) \qquad [ Equation 8 ]$$

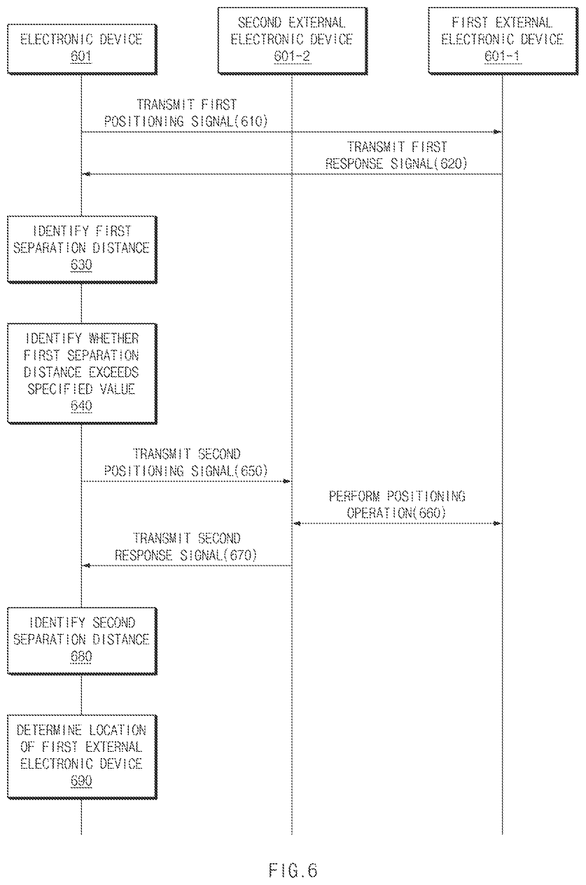

FIG. 6 is a signal flow diagram illustrating an example positioning function performed by an electronic device 601 with a plurality of external electronic devices 601-1 and 601-2 according to various embodiments.

Referring to FIG. 6, according to an embodiment, the electronic device 601 (e.g., the electronic device 101 of FIG. 1) may transmit and/or receive an electric signal to/from one or more external electronic devices (e.g., the first external electronic device 601-1 and the second external electronic device 601-2). Hereinafter, an operation in which the electronic device 601 performs a positioning function will be described in sequence.

Referring to reference number 610, the electronic device 601 may transmit a first positioning signal to the first external electronic device 601-1. For example, the electronic device 601 may transmit the first positioning signal to the first external electronic device 601-1 using a wireless communication circuit (e.g., the communication module 190 of FIG. 1). The electronic device 601 may transmit the first positioning signal based on an ultra-wideband (UWB) protocol, but embodiments of the present disclosure are not limited thereto. For example, the electronic device 601 may establish a wireless communication channel with the first external electronic device 601-1 using Bluetooth low energy (BLE) communication. The electronic device 601 may request, based on the established communication channel, the first external electronic device 601-1 to perform UWB protocol-based communication. For another example, the electronic device 601 may receive a specified input to at least one region of a display module (e.g., the display module 160 of FIG. 1), and may transmit the first positioning signal to the first external electronic device 601-1. The first positioning signal may be referred to as the above-mentioned request message of FIG. 3B. The specified input may be a user's touch input to one region of a user interface for providing a function of searching for the location of the first external electronic device 601-1.

Referring to reference number 620, the first external electronic device 601-1 may transmit a first response signal to the electronic device 601. For example, the first external electronic device 601-1 may transmit the first response signal in response to the first positioning signal received from the electronic device 601. The first response signal may be referred to as the above-mentioned response message of FIG. 3B.

Referring to reference number 630, the electronic device 601 may identify a first separation distance. For example, the electronic device 601 may identify location information based on the first response signal received from the first external electronic device 601-1. For example, the electronic device 601 may calculate and/or identify the first separation distance between the electronic device 601 and the first external electronic device 601-1 based on the first response signal. For another example, the electronic device 601 may calculate an angle of arrival between the electronic device 601 and the first external electronic device 601-1 based on the first response signal. Descriptions of an operation of calculating the angle of arrival by the electronic device 601 may be replaced with the above descriptions provided with regard to FIGS. 4 and 5.

Referring to reference number 640, the electronic device 601 may determine whether the first separation distance exceeds a specified value. For example, the electronic device 601 may determine whether the first separation distance calculated and/or identified in reference number 630 exceeds the specified value. In an embodiment, the angle of arrival calculated by the electronic device 601 when the first separation distance is equal to or less than the specified value may have higher accuracy than the angle of arrival calculated by the electronic device 601 when the first separation distance exceeds the specified value. For example, a difference between a maximum value and minimum value of the angle of arrival calculated by the electronic device 601 when the first separation distance is equal to or less than the specified value may be less than the difference between the maximum value and minimum value of the angle of arrival calculated by the electronic device 601 when the first separation distance exceeds the specified value.

In an embodiment, if the first separation distance is identified as being equal to or less than the specified value, the electronic device 601 may not transmit a second positioning signal to the second external electronic device 601-2. For example, if the first separation distance is equal to or less than the specified value, the electronic device 601 may not transmit the second positioning signal to the second external electronic device 601-2. For example, the electronic device 601 may display, on a display (e.g., the display module 160 of FIG. 1), the location information calculated and/or identified in reference number 630.

In an embodiment, if the first separation distance is identified as exceeding the specified value, the electronic device 601 may transmit the second positioning signal to the second external electronic device 601-2. For example, if the first separation distance exceeds the specified value, the electronic device 601 may transmit the second positioning signal to the second external electronic device 601-2.

Referring to reference number 650, the electronic device 601 may transmit the second positioning signal to the second external electronic device 601-2. For example, the electronic device 601 may transmit the second positioning signal to the second external electronic device 601-2 using a wireless communication circuit. The electronic device 601 may transmit the second positioning signal based on an ultra-wideband (UWB) protocol, but embodiments of the present disclosure are not limited thereto. The second positioning signal may be referred to as the above-mentioned request message of FIG. 3B.

Referring to reference number 660, the first external electronic device 601-1 and the second external electronic device 601-2 may perform a positioning operation. For example, the first external electronic device 601-1 and the second external electronic device 601-2 may transmit/receive various signals (e.g., the request message and response message of FIG. 3B) for performing the positioning operation, and may obtain location information based on these signals.

Referring to reference number 670, the second external electronic device 601-2 may transmit a second response signal to the electronic device 601. For example, the second external electronic device 601-2 may transmit the second response signal in response to the second positioning signal received from the electronic device 601. For example, the second response signal may be referred to as the above-mentioned response message of FIG. 3B. For example, the second response signal is a signal generated by the first external electronic device 601-1 and the second external electronic device 601-2 by performing the positioning operation, and may include location information (e.g., an angle of arrival or separation distance) between the first external electronic device 601-1 and the second external electronic device 601-2. Additionally or alternatively, the second response signal is a signal generated by the second external electronic device 601-2 in response to transmission of the second positioning signal, and may include an angle of arrival or separation distance between the electronic device 601 and the second external electronic device 601-2. For example, the electronic device 601 may receive the second response signal based on a Bluetooth protocol, but embodiments of the present disclosure are not limited thereto.

Referring to reference number 680, the electronic device 601 may identify a second separation distance. For example, the electronic device 601 may calculate and/or identify the second separation distance that is a separation distance between the first external electronic device 601-1 and the second external electronic device 601-2 based on the second response signal received from the second external electronic device 601-2. For another example, the electronic device 601 may identify an angle of arrival between the first external electronic device 601-1 and the second external electronic device 601-2 based on the second response signal. For another example, the electronic device 601 may calculate and/or identify a separation distance between the electronic device 601 and the second external electronic device 601-2 based on the second response signal.

Referring to reference number 690, the electronic device 601 may determine the location of the first external electronic device. For example, the electronic device 601 may determine that the first external electronic device 601-1 is located within an overlapping region among a first radius region corresponding to the first separation distance, a second radius region corresponding to the second separation distance, and a region corresponding to the angle of arrival. For example, the first radius region may be referred to as a circular region with the electronic device 601 as a center and the first separation distance as a radius. For another example, the second radius region may be referred to as a circular region with the second external electronic device 601-2 as a center and the second separation distance as a radius. For another example, the region corresponding to the angle of arrival may be referred to as a fan-shaped region corresponding to the angle of arrival obtained by the electronic device 601.

Meanwhile, the order of the above-mentioned operations in which the electronic device 601 perform wireless communication with the external electronic devices 601-1 and 601-2 is merely illustrative, and embodiments of the present disclosure are not limited thereto. For example, if a specified condition is satisfied in reference number 640, the electronic device 601 may skip the operation of calculating the angle of arrival with the first external electronic device 601-1, and may perform the operations of reference numbers 650 to 680.

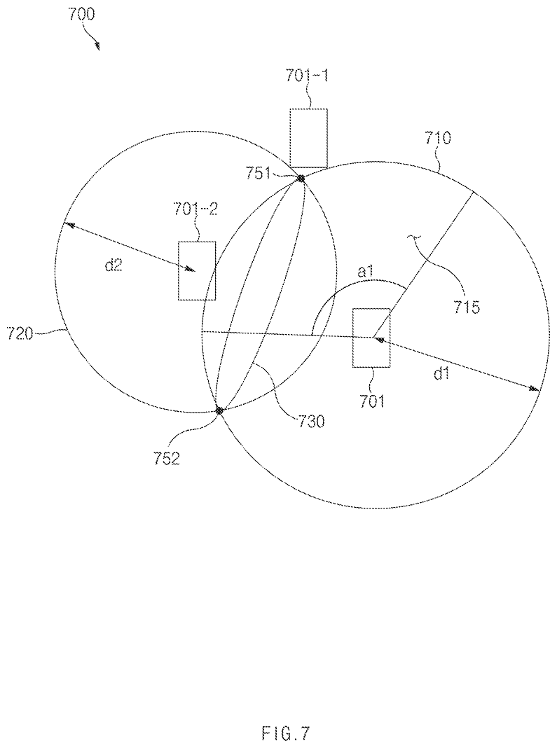

FIG. 7 is a diagram 700 illustrating an example positioning function performed by an electronic device 701 with a plurality of external electronic devices 701-1 and 701-2 according to various embodiments.

According to an embodiment, the electronic device 701 (e.g., the electronic device 101 of FIG. 1) may identify the location of a specified external electronic device (e.g., the first external electronic device 701-1) by performing a positioning operation with at least one external electronic device (e.g., the first external electronic device 701-1 and the second external electronic device 701-2). For example, the electronic device 701 may transmit and receive a signal for performing the positioning operation to/from the first external electronic device 701-1 (e.g., the first external electronic device 201-1 of FIG. 2) and the second external electronic device 701-2 (e.g., the second external electronic device 201-2 of FIG. 2) using a wireless communication circuit (e.g., the communication module 190 of FIG. 1).

According to an embodiment, the electronic device 701 may transmit a first positioning signal to the first external electronic device 701-1 and receive a first response signal corresponding to the first positioning signal from the first external electronic device 701-1. For example, the first positioning signal and the first response signal may be respectively referred to as the above-mentioned request message and response message of FIG. 3B. For example, the electronic device 701 may identify a first separation distance d1 that is a separation distance between the electronic device 701 and the first external electronic device 701-1 based on the received first response signal. The electronic device 701 may identify a first radius region 710 corresponding to the first separation distance d1. For example, the first radius region 710 may be referred to as a circular region with the electronic device 701 as a center and the first separation distance d1 as a radius. For another example, the electronic device 701 may identify an angle of arrival a1 between the electronic device 701 and the first external electronic device 701-1 based on the received first response signal.

According to an embodiment, the electronic device 701 may identify whether the first separation distance d1 exceeds a specified value.

In an embodiment, if the first separation distance d1 is identified as being equal to or less than the specified value, the electronic device 701 may not transmit a second positioning signal to the second external electronic device 701-2. For example, if the first separation distance d1 is equal to or less than the specified value, the electronic device 701 may display location information of the first external electronic device 701-1 identified based on the first response signal.

In an embodiment, if the first separation distance is identified as exceeding the specified value, the electronic device 701 may transmit the second positioning signal to the second external electronic device 701-2. For example, if the first separation distance d1 exceeds the specified value, the electronic device 701 may perform wireless communication with the second external electronic device 701-2. For example, the electronic device 701 may transmit the second positioning signal to the second external electronic device 701-2 and receive a second response signal corresponding to the second positioning signal from the second external electronic device 701-2. The second positioning signal and the second response signal may be respectively referred to as the above-mentioned request message and response message of FIG. 3B.

In an embodiment, the electronic device 701 may identify location information based on the second response signal. For example, the electronic device 701 may identify location information between the first electronic device 701-1 and the second electronic device 701-2 and/or location information between the electronic device 701 and the second electronic device 701-2 based on the second response signal.

For example, the electronic device 701 may identify a second separation distance d2 that is a separation distance between the first external electronic device 701-1 and the second external electronic device 701-2 based on the received second response signal.

For example, the electronic device 701 may identify a second radius region 720 corresponding to the second separation distance d2. The second radius region 720 may be referred to as a circular region with the electronic device 701 as a center and the second separation distance d2 as a radius.

For example, the electronic device 701 may identify an angle of arrival between the first external electronic device 701-1 and the second external electronic device 701-2 based on the received second response signal.

For example, the electronic device 701 may identify a separation distance between the electronic device 701 and the second external electronic device 701-2 and/or an angle of arrival between the electronic device 701 and the second external electronic device 701-2 based on the second response signal.

According to an embodiment, the electronic device 701 may identify location information of the first external electronic device 701-1 based on the above-mentioned positioning operations. For example, the electronic device 701 may identify at least one point at which the first radius region 710 and the second radius region 720 contact each other, and may identify an overlapping region 730 between the first radius region 710 and the second radius region 720 using the at least one identified contact point. The overlapping region 730 between the first radius region 710 and the second radius region 720 may intersect with the first radius region 710 and the second radius region 720 at a first point 751 and a second point 752. For example, the overlapping region 730 between the first radius region 710 and the second radius region 720 may be referred to as a circular region that substantially intersects at right angles with the first radius region 710 and the second radius region 720 and has a distance between the first point 751 and the second point 752 as a diameter. The electronic device 701 may determine that the first external electronic device 701-1 is located within an overlapping region (e.g., the first point 751) between a region 715 corresponding to the angle of arrival a1 and the overlapping region 730 between the first radius region 710 and the second radius region 720. For example, since the first point 751 among the first point 751 and the second point 752 overlaps the region 715 corresponding to the angle of arrival a1, the electronic device 701 may determine that the first external electronic device 701-1 is located in a region adjacent to the first point 751.

FIG. 8 is a diagram 800 illustrating an example positioning function performed by an electronic device 801 with a plurality of external electronic devices 801-1, 801-2, and 801-3 according to various embodiments.

According to an embodiment, the electronic device 801 (e.g., the electronic device 101 of FIG. 1) may identify the location of a specified external electronic device (e.g., the first external electronic device 801-1) by performing a positioning operation with external electronic devices (e.g., the first external electronic device 801-1, the second external electronic device 801-2, and the third external electronic device 801-3). For example, the electronic device 801 may transmit and receive a signal for performing the positioning operation to/from the first external electronic device 801-1 (e.g., the first external electronic device 201-1 of FIG. 2), the second external electronic device 801-2 (e.g., the second external electronic device 201-2 of FIG. 2), and the third external electronic device 801-3 using a wireless communication circuit (e.g., the communication module 190 of FIG. 1). Meanwhile, descriptions of embodiments that are the same as or similar to the embodiment illustrated in FIG. 7 may be replaced with the above descriptions provided with regard to FIG. 7. Hereinafter, the embodiment illustrated in FIG. 8 will be described with a focus on differences with the embodiment illustrated in FIG. 7. For example, the electronic device 801 may determine the location of the first external electronic device 801-1 without calculating and/or identifying an angle of arrival with the first external electronic device 801-1 by performing wireless communication with an additional electronic device (e.g., the third external electronic device 801-3).

According to an embodiment, the electronic device 801 may transmit a first positioning signal to the first external electronic device 801-1 and receive a first response signal corresponding to the first positioning signal from the first external electronic device 801-1. The electronic device 801 may identify a first separation distance d1 that is a separation distance between the electronic device 801 and the first external electronic device 801-1 and identify a first radius region 810 corresponding to the first separation distance d1 based on the received first response signal.

According to an embodiment, the electronic device 801 may perform wireless communication with the second external electronic device 801-2. For example, the electronic device 801 may transmit a second positioning signal to the second external electronic device 801-2 and receive a second response signal corresponding to the second positioning signal from the second external electronic device 801-2. The electronic device 801 may identify a second separation distance d2 that is a separation distance between the first external electronic device 801-1 and the second external electronic device 801-2 and identify a second radius region 820 corresponding to the second separation distance d2 based on the received second response signal.

According to an embodiment, the electronic device 801 may perform wireless communication with the third external electronic device 801-3. For example, the electronic device 801 may transmit a third positioning signal to the third external electronic device 801-3 and receive a third response signal corresponding to the third positioning signal from the third external electronic device 801-3. For example, the electronic device 801 may transmit the third positioning signal based on an ultra-wideband (UWB) protocol. For another example, the electronic device 801 may receive the third response signal based on a Bluetooth protocol. For example, the electronic device 801 may calculate and/or identify a separation distance between the electronic device 801 and the third external electronic device 801-3 based on the third response signal received from the third external electronic device 801-3. For another example, the electronic device 801 may calculate and/or identify a third separation distance d3 that is a separation distance between the first external electronic device 801-1 and the third external electronic device 801-3 based on the third response signal received from the third external electronic device 801-3. The electronic device 801 may identify a third radius region 830 corresponding to the third separation distance d3 based on the received third response signal.

According to an embodiment, the electronic device 801 may determine the location of the first external electronic device 801-1 using the calculated and/or identified first separation distance d1, second separation distance d2, and third separation distance d3. For example, the electronic device 801 may identify an overlapping region 840 (e.g., reference number 730 of FIG. 7) between the first radius region 810 corresponding to the first separation distance d1 and the second radius region 820 corresponding to the second separation distance d2. For example, the overlapping region 840 between the first radius region 810 and the second radius region 820 may intersect with the first radius region 810 and the second radius region 820 at a first point 851 and a second point 852. The overlapping region 840 between the first radius region 810 and the second radius region 820 may be referred to as a circular region that substantially intersects at right angles with the first radius region 810 and the second radius region 820 and has a distance between the first point 851 and the second point 852 as a diameter. The electronic device 801 may determine that the first external electronic device 801-1 is located within an overlapping region (e.g., the first point 851) between a region 830 and the overlapping region 840 between the first radius region 810 and the second radius region 820. For example, since the first point 851 among the first point 851 and the second point 852 overlaps the overlapping region 840 between the first radius region 810 and the second radius region 820 and the third radius region 830, the electronic device 801 may determine that the first external electronic device 801-1 is located in a region adjacent to the first point 851.

The descriptions of the components illustrated in FIG. 8 is merely illustrative, and embodiments of the present disclosure are not limited thereto. For example, the electronic device 801 may determine the location of a particular external electronic device (e.g., the first external electronic device 801-1) by performing wireless communication with additional external electronic devices in addition to the three illustrated external electronic devices 801-1, 801-2, and 801-3. In an embodiment, at least some of a plurality of external electronic devices performing wireless communication with the electronic device 801 may be electronic devices owned by the same user. For example, the first external electronic device 801-1 and the second external electronic device 801-2 may be referred to as electronic devices including the same account information or belonging to the same group as the electronic device 801. The same account information may include the same identifier (e.g., synced identifier), a Bluetooth address of the same representative device (e.g., the electronic device 801), or the same account information-based value (e.g., hash value). For another example, the third external electronic device 801-3 and a plurality of additional external electronic devices (not shown) performing wireless communication may include account information different from that of the electronic device 801. In other words, external electronic devices except for the first external electronic device 801-1 and the second external electronic device 801-2 may be electronic devices owned by a user different from the user of the electronic device 801.

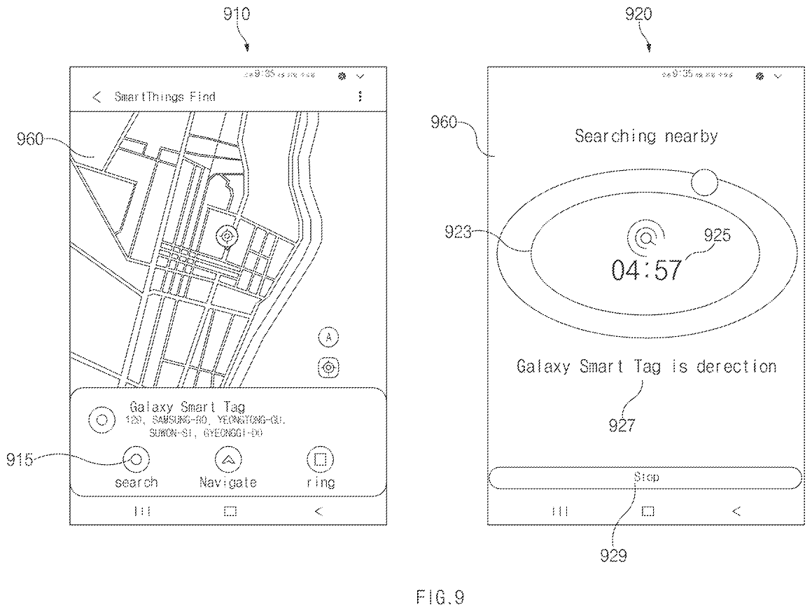

FIG. 9 is a diagram illustrating an example user interface displayed on a display by an electronic device according to various embodiments.

Referring to FIG. 9, according to an embodiment, an electronic device (e.g., the electronic device 101 of FIG. 1) may display, on a display 960 (e.g., the display module 160 of FIG. 1), a user interface corresponding to a function for performing a positioning operation.

Referring to reference number 910, according to an embodiment, the electronic device may display a user interface including a plurality of graphic user interfaces (GUIs) on the display 960.

For example, the electronic device may display, on the display 960, a GUI (e.g., arrow) indicating information (e.g., area name, building name, and/or road name) about a region adjacent to a region where the electronic device is located and information about a point at which the electronic device is located.

For example, the electronic device may display, on the display 960, a first GUI 915 for starting a function of searching for the location of an external electronic device in response to a specified input. If a user's specified input to the first GUI 915 is received, the electronic device may switch a screen displayed on the display 960 to a screen of reference number 920.

For example, the electronic device may display, on the display 960, a GUI for starting a function of displaying a guide screen to guide to a location wherein an external electronic device is arranged in response to the specified input.

For example, the electronic device may display, on the display 960, a GUI for starting a function of transmitting a control signal that causes an external electronic device to output a specified sound in response to the specified input.

Referring to reference number 920, according to an embodiment, the electronic device may receive a specified input to the first GUI 915, and perform a positioning operation by performing wireless communication with a plurality of external electronic devices (e.g., the first electronic device 201-1 and the second external electronic device 201-2 of FIG. 2). For example, the electronic device may display, on the display 960, a plurality of GUIs indicating an execution degree and/or progress of the positioning operation while performing the positioning operation. For example, the electronic device may display, on the display 960, a substantially circular second GUI 923 indicating the execution degree and/or progress of the positioning operation and a third GUI 925 indicating an execution elapse time of the positioning operation. For another example, if the user switches the user interface that is displayed during the execution of the positioning operation to another screen, the electronic device may display, on the display 960, a first text 927 indicating that an alarm function will be provided when the positioning operation is completed. For another example, the electronic device may display, on the display 960, a fourth GUI 929 for ending the execution of the positioning operation.

In the descriptions related to FIG. 9, the specified input may be a user's touch input to the display 960. For example, the specified input may be a single tap. The single tap may be a touch input having one contact point on the display 960. For another example, the touch input may be a multi-tap. The multi-tap may be a motion having two or more contact points on the display 960.

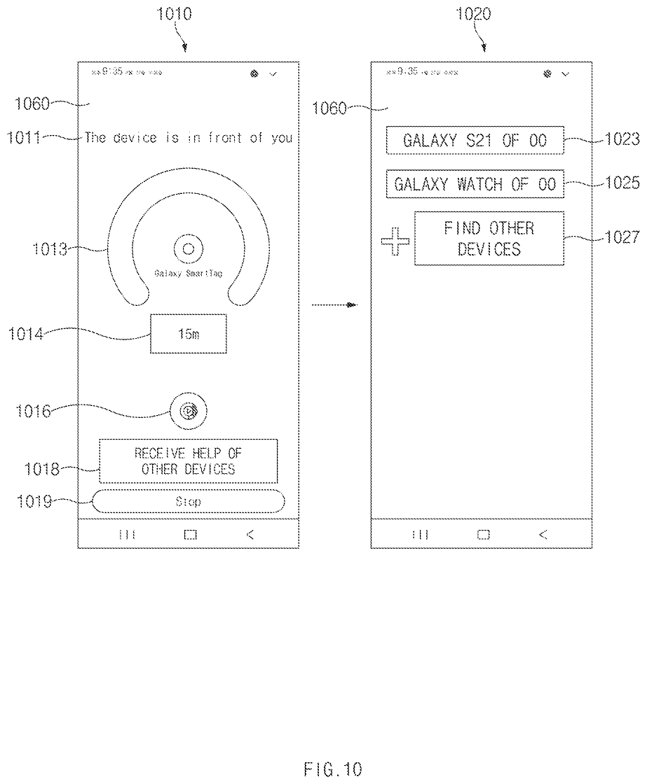

FIG. 10 is a diagram illustrating an example user interface displayed on a display by an electronic device according to various embodiments.

Referring to FIG. 10, according to an embodiment, an electronic device (e.g., the electronic device 101 of FIG. 1) may display, on a display 1060 (e.g., the display module 160 of FIG. 1), a user interface corresponding to a function for performing a positioning operation.

Referring to reference number 1010, according to an embodiment, the electronic device may display a plurality of GUIs and/or text on the user interface. For example, the electronic device may display, on the display 1060, a second text 1011 indicating direction information of an external electronic device (e.g., the first external electronic device 201-1 of FIG. 2) to be obtained through the positioning operation. For another example, the electronic device showing the execution degree and/or progress of the positioning operation may display, on the display 1060, a substantially circular fourth GUI 1013 indicating completion of the positioning operation and a third text 1014 indicating a separation distance to the external electronic device. For another example, the electronic device may further display, on the display 1060, a fifth GUI 1016 for performing an alarm function or audio function, a sixth GUI 1018 for showing a list of external electronic devices with which to perform wireless communication additionally during the execution of the positioning operation, and/or a seventh GUI 1019 for ending the positioning operation. If a user's specified input (e.g., touch input) to the sixth GUI 1018 is received, the electronic device may switch a screen displayed on the display 1060 to a screen of reference number 1020.

Referring to reference number 1020, according to an embodiment, the electronic device may display, on the display 1060, a list of external electronic devices (e.g., the third external electronic device 801-3 of FIG. 8) with which to perform wireless communication additionally during the execution of the positioning operation. For example, the electronic device may display, on the display 1060, an eighth GUI 1023 including information of a third external electronic device capable of performing wireless communication with the electronic device and a ninth GUI 1025 including information of a fourth external electronic device. For example, at least one of the third external electronic device or the fourth external electronic device may be referred to as electronic devices that include the same account information or belong to the same group as the electronic device. The same account information may include the same identifier (e.g., synced identifier), a Bluetooth address of the same representative device (e.g., the electronic device 201), or the same account information-based value (e.g., hash value). For another example, at least one of the third external electronic device or the fourth external electronic device may not include the same account information as the electronic device. For example, at least one of the third external electronic device or the fourth external electronic device may be one owned by a user different from the user of the electronic device. If a specified input (e.g., touch input) to the eighth GUI 1023 or the ninth GUI 1025 is received, the electronic device may perform wireless communication (e.g., Bluetooth communication and/or UWB communication) with an external electronic device corresponding to a GUI on which an input has been sensed. In an embodiment, the electronic device may further display, on the display 1060, a 10th GUI 1027 for searching for an external electronic device capable of performing wireless communication in addition to the displayed list of the plurality of external electronic devices 1023 and 1025.

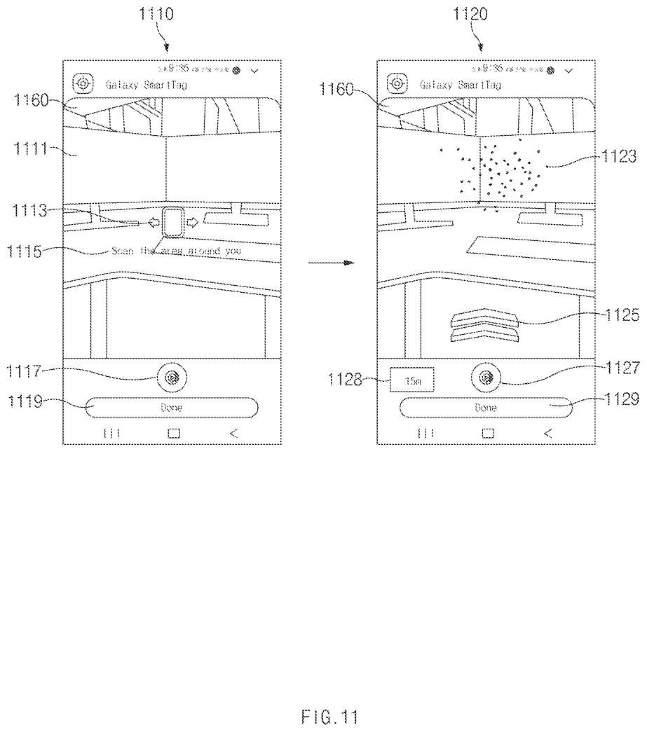

FIG. 11 is a diagram illustrating an example user interface displayed on a display by an electronic device according to various embodiments.

Referring to FIG. 11, according to an embodiment, an electronic device (e.g., the electronic device 101 of FIG. 1) may display, on a display 1160 (e.g., the display module 160 of FIG. 1), information associated with the location of an external electronic device determined through a positioning operation.

Referring to reference number 1110, according to an embodiment, the electronic device may display, on the display 1160, a view 1111 obtained using a camera module (e.g., the camera module 180 of FIG. 1). The electronic device may determine the location of an external electronic device (e.g., the first external electronic device 202-1 of FIG. 2) based on the positioning operations described above with reference to FIGS. 9 and 10, and may display information associated with the determined location on the display 1160. For example, if it is identified that the external electronic device is not located within the view 1111, the electronic device may display, on the display 1160, an 11th GUI 1113 and fourth text 1115 for guiding to move the electronic device. For another example, the electronic device may further display, on the display 1160, a 12th GUI 1117 for performing an alarm function or audio function and/or a 13th GUI 1119 for ending the positioning operation.

Referring to reference number 1120, according to an embodiment, if it is identified that the external electronic device is present within the view obtained using the camera module, the electronic device may display the location of the external electronic device on the display 1160. For example, the electronic device may display, on the display 1160, a 14th GUI 1123 indicating the location of the external electronic device. For another example, the electronic device may display, on the display 1160, a 15th GUI 1125 indicating information about a direction in which the external electronic device is located. In this case, the electronic device may additionally display, in one region of the display 1160, a fifth text 1128 indicating a separation distance to the external electronic device. For another example, the electronic device may further display, on the display 1160, a 16th GUI 1127 for performing an alarm function or audio function and/or a 17th GUI 1129 for ending the positioning operation.

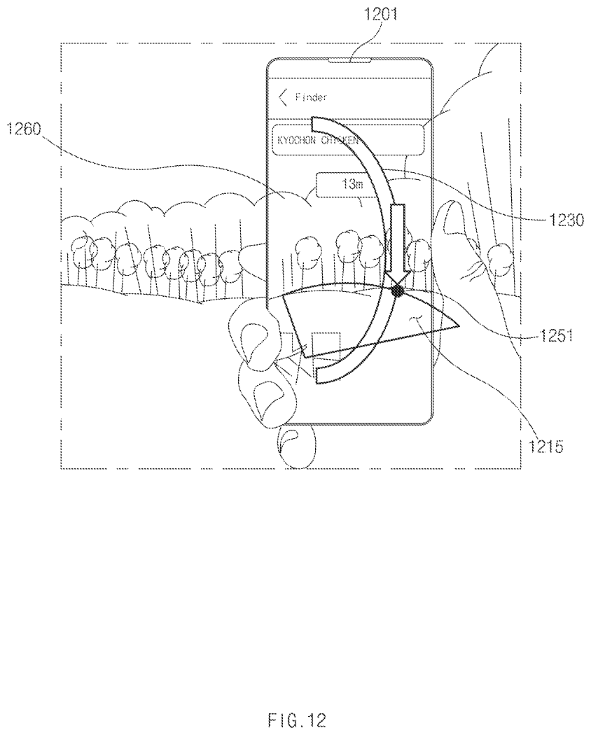

FIG. 12 is a diagram illustrating an example user interface displayed on a display by an electronic device according to various embodiments.

Referring to FIG. 12, according to an embodiment, an electronic device 1201 (e.g., the electronic device 101 of FIG. 1) may display, on a display 1260 (e.g., the display module 160 of FIG. 1), a user interface including a result calculated and/or identified through a positioning operation. For example, the electronic device 1201 may display location information of an external electronic device on the display 1260.

According to an embodiment, the electronic device 1201 may perform the positioning operation described above with reference to FIGS. 3A to 8. For example, the electronic device 1201 may identify a first radius region (e.g., the first radius region 710 or 810 of FIG. 7 or 8) and a second radius region (e.g., the second radius region 720 or 820 of FIG. 7 or 8) and identify an overlapping region 1230 between the first radius region and the second radius region using various response signals received by performing wireless communication with a first external electronic device (e.g., the first external electronic device 201-1 of FIG. 2) and a second external electronic device (e.g., the second external electronic device 201-2 of FIG. 2).

According to an embodiment, the electronic device 1201 may perform the positioning operation described above with reference to FIGS. 3A to 8. For example, the electronic device 1201 may calculate and/or identify an angle of arrival with the first external electronic device using a first response signal received by performing wireless communication with the first external electronic device. The electronic device 1201 may identify a region 1215 corresponding to the calculated and/or identified angle of arrival.

According to an embodiment, the electronic device 1201 may display, on the display 1260, the overlapping region 1230 between the first radius region and the second radius region and the region 1215 corresponding to the angle of arrival. The electronic device 1201 may determine that the first external electronic device is located at a first point 1251 that is one point in an overlapping region between the above regions, and may display information associated with the first point 1251 together on the display 1260. For example, the electronic device 1201 may display, on the display 1260, guide information and information associated with a direction to a region in which the first external electronic device has been determined to be located with respect to the electronic device 1201.

The descriptions of FIG. 12 include descriptions of a user interface corresponding to the embodiment of FIG. 7, and embodiments of the present disclosure are not limited thereto. For example, the electronic device 1201 according to the embodiment of FIG. 8 may skip the measurement of an angle of arrival and determine the location of the first external electronic device. Therefore, in this case, the electronic device 1201 may not display, on the use interface, information about the region 1215 corresponding to the angle of arrival.

The above-mentioned user interface display method of the electronic device illustrated and described in FIGS. 9 to 12 is illustrative, and embodiments of the present disclosure are not limited thereto. For example, the electronic device may acoustically provide the location information of an external electronic device to the user using a sound output module (e.g., the sound output module 155 of FIG. 1) without visually displaying the location information using a display. For another example, the user interface, the plurality of GUIs, and/or text displayed by the electronic device are illustrative, and all and/or some of the elements of the screen illustrated may not be displayed.

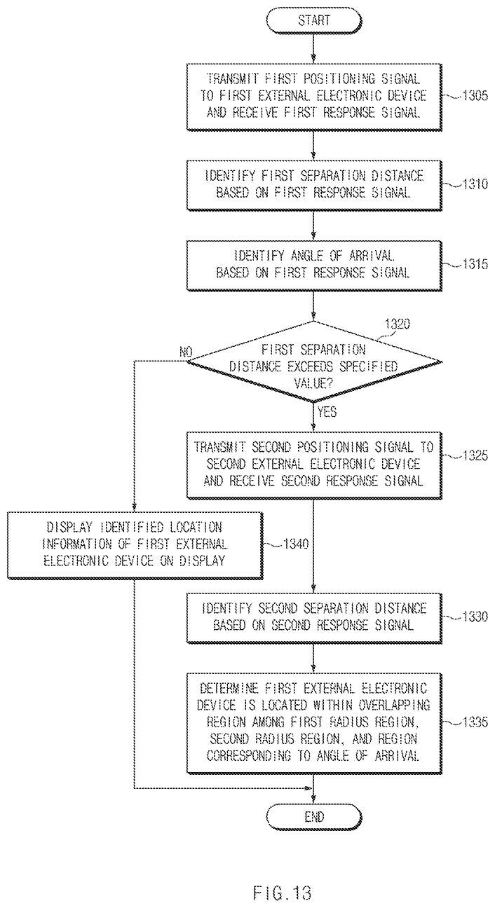

FIG. 13 is a flowchart illustrating an example operation of an electronic device according to various embodiments.

According to an embodiment, an electronic device (e.g., the electronic device 101 of FIG. 1) may perform the operations disclosed in FIG. 13. For example, a processor (e.g., the processor 120 of FIG. 1) of the electronic device may be configured to perform the operations of FIG. 13 when executing instructions stored in a memory (e.g., the memory 130 of FIG. 1).

In operation 1305, the electronic device may transmit a first positioning signal (e.g., the request message of FIG. 3B) to a first external electronic device (e.g., the first external electronic device 201-1 of FIG. 2) and receive a first response signal (e.g., the response message of FIG. 3B). For example, the first response signal may be referred to as an electric signal generated by the first external electronic device in response to the first positioning signal received from the electronic device. For example, the first response signal may include information about a time at which the first positioning signal was received and a time at which the first response signal was transmitted.

In operation 1310, the electronic device may identify a first separation distance (e.g., the first separation distance d1 of FIG. 7 or 8) based on the first response signal. For example, the electronic device may identify the first separation distance that is a separation distance between the electronic device and the first external electronic device and identify a first radius region (e.g., the first radius region 710 of FIG. 7) corresponding to the first separation distance based on the received first response signal. For example, the first radius region may be referred to as a circular region with the electronic device as a center and the first separation distance as a radius.

In operation 1315, the electronic device may identify an angle of arrival based on the first response signal. For example, the electronic device may identify the angle of arrival (e.g., the angle of arrival a1 of FIG. 7) with the first external electronic device and identify a region (e.g., the region 715 corresponding to an angle of arrival of FIG. 7) corresponding to the angle of arrival based on the first response signal.

In operation 1320, the electronic device may determine whether the first separation distance exceeds a specified value. For example, if the first separation distance exceeds the specified value (e.g., operation 1320—Yes), the electronic device may perform operation 1325. For another example, if the first separation distance does not exceed the specified value (e.g., operation 1320—No), the electronic device may perform operation 1340.

In operation 1325, the electronic device may transmit a second positioning signal (e.g., the request message of FIG. 3B) to a second external electronic device (e.g., the second external electronic device 201-2 of FIG. 2) and receive a second response signal (e.g., the response message of FIG. 3B). For example, the second response signal may be referred to as an electric signal generated by the second external electronic device in response to the second positioning signal received from the electronic device.

In operation 1330, the electronic device may identify a second separation distance (e.g., the second separation distance d2 of FIG. 7 or 8) based on the second response signal. For example, the electronic device may identify the second separation distance that is a separation distance between the first external electronic device and the second external electronic device and identify a second radius region (e.g., the second radius region 720 of FIG. 7) corresponding to the second separation distance based on the received second response signal. For example, the second radius region may be referred to as a circular region with the electronic device as a center and the second separation distance as a radius.

In operation 1335, the electronic device may determine that the first external electronic device is located within an overlapping region (e.g., the first point 751 of FIG. 7) among the first radius region, the second radius region, and the region corresponding to the angle of arrival. For example, the electronic device may identify at least one point at which the first radius region and the second radius region contact each other, and may identify an overlapping region between the first radius region and the second radius region using the at least one identified contact point. The overlapping region (e.g., the overlapping region 730 between the first radius region and the second radius region of FIG. 7) between the first radius region and the second radius region may be identified. The overlapping region between the first radius region and the second radius region may intersect with the first radius region and the second radius region at the first point and a second point (e.g., the second point 752 of FIG. 7). For example, the overlapping region between the first radius region and the second radius region may be referred to as a circular region that substantially intersects at right angles with the first radius region and the second radius region and has a distance between the first point and the second point as a diameter. The electronic device may identify an overlapping region between the region corresponding to the angle of arrival and the overlapping region between the first radius region and the second radius region. The electronic device may determine that the first external electronic device is located at one point in the overlapping region among the three regions, e.g., at a region adjacent to the first point.

In operation 1340, the electronic device may display location information of the first external electronic device on a display (e.g., the display module 160 of FIG. 1). For example, the location information of the first external electronic device calculated and/or identified based on the first response signal when the first separation distance is equal to or less than the specified value may be relatively more accurate information compared to the location information of the first external electronic device calculated and/or identified based on the first response signal when the first separation distance exceeds the specified value. Therefore, if the first separation distance is determined to be equal to or less than the specified value, the electronic device may display, on the display, the location information of the first external electronic device including the first separation distance and angle of arrival identified in operation 1310 and operation 1315 without performing communication with the second external electronic device.

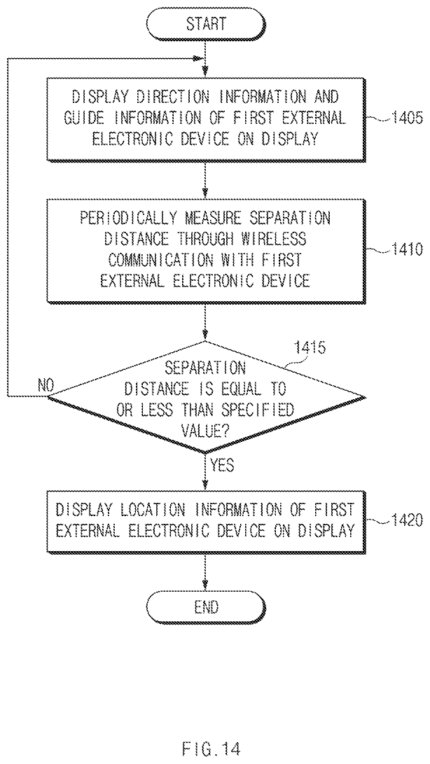

FIG. 14 is a flowchart illustrating an example operation of an electronic device according to various embodiments.

According to an embodiment, an electronic device (e.g., the electronic device 101 of FIG. 1) may perform the operations disclosed in FIG. 14. For example, a processor (e.g., the processor 120 of FIG. 1) of the electronic device may be configured to perform the operations of FIG. 14 when executing instructions stored in a memory (e.g., the memory 130 of FIG. 1).

In operation 1405, the electronic device may display guide information and direction information of the first external electronic device on a display (e.g., the display module 160 of FIG. 1). For example, the electronic device may display, on the display, a user interface including the direction information and location information of the first external electronic device determined through the above-mentioned operations of FIG. 10 and/or guide information for directing the electronic device to the location of the first external electronic device.

In operation 1410, the electronic device may periodically measure a separation distance between the electronic device and the first external electronic device through wireless communication with the first external electronic device. For example, descriptions of the positioning operation performed by the electronic device in operation 1410 may be replaced with the above descriptions provided with regard to FIGS. 3A to 5.

In operation 1415, whether the measured separation distance is equal to or less than a specified value may be determined. For example, if the separation distance is determined to be equal or less than the specified value (e.g., operation 1415—Yes), the electronic device may perform operation 1420. For another example, if the separation distance is determined to exceed the specified value (e.g., operation 1415—No), the electronic device may repeatedly perform operation 1405.

In operation 1420, the electronic device may display the location information of the first external electronic device on the display. For example, since the separation distance between the electronic device and the first external electronic device does not exceed the specified value, the electronic device may relatively accurately identify and determine the location information of the first external electronic device. Therefore, the electronic device may display, on the display, a user interface including the location information of the first external electronic device determined through the above-mentioned operations.

An electronic device according to an example embodiment of the present disclosure may include: a wireless communication circuit, at least one processor, and a memory. The memory may store instructions that, when executed by one or more of the at least one processor, cause the electronic device to: transmit a first positioning signal to a first external electronic device and receive a first response signal corresponding to the first positioning signal from the first external electronic device using the wireless communication circuit; identify a first separation distance between the electronic device and the first external electronic device and an angle of arrival between the electronic device and the first external electronic device based on the received first response signal; based on the first separation distance being determined to exceed a specified value, transmit a second positioning signal to a second external electronic device and receive a second response signal corresponding to the second positioning signal from the second external electronic device; identify a second separation between the first external electronic device and the second external electronic device based on the received second response signal; and determine that the first external electronic device is located within an overlapping region among a first radius region corresponding to the first separation distance, a second radius region corresponding to the second separation distance, and a region corresponding to the angle of arrival.

According to an example embodiment, the second response signal may include information associated with a separation distance between the electronic device and the second external electronic device.

According to an example embodiment, the instructions may, when executed by one or more of the at least one processor, cause the electronic device to: transmit the first positioning signal to the first external electronic device and transmit the second positioning signal to the second external electronic device based on an ultra-wideband (UWB) protocol.

According to an example embodiment, the instructions, when executed by one or more of the at least one processor, cause the electronic device to receive the second response signal corresponding to the second positioning signal from the second external electronic device based on a Bluetooth protocol.

According to an example embodiment, the electronic device, the first external electronic device, and the second external electronic device may belong to a same account or a same group.

According to an example embodiment, the first radius region may include a substantially circular region with the electronic device as a center and the first separation distance as a radius, and the second radius region may include a substantially circular region with the second external electronic device as a center and the second separation distance as a radius.

According to an example embodiment, the instructions, when executed by one or more of the at least one processor, cause the electronic device to: transmit the first positioning signal to the first external electronic device based on receiving a specified input, wherein the specified input may include a touch input to a user interface for providing a function of searching for the location of the first external electronic device.

According to an example embodiment, the electronic device may further include: a display, and the instructions, when executed by one or more of the at least one processor, cause the electronic device to: display, on the display, guide information and information associated with a direction to a region in which the first external electronic device has been determined to be located with respect to the electronic device.

According to an example embodiment, the instructions, when executed by one or more of the at least one processor, cause the electronic device to: identify, at specified intervals, the separation distance between the electronic device and the first external electronic device based on a UWB protocol, and, based on the identified separation distance being determined to be equal to or less than the specified value, display determined location information of the first external electronic device on the display.

According to an example embodiment, the instructions, when executed by one or more of the at least one processor, cause the electronic device to: transmit a third positioning signal to a third external electronic device and receive a third response signal corresponding to the third positioning signal from the third external electronic device using the wireless communication circuit; identify a third separation distance between the first external electronic device and the third external electronic device based on the received third response signal; and determine that the first external electronic device is located within an overlapping region among the first radius region, the second radius region, and a third radius region corresponding to the third separation distance. For example, the third radius region may include a substantially circular region with the third external electronic device as a center and the third separation distance as a radius.

A method of operating an electronic device to perform a positioning operation according to an example embodiment of the present disclosure may comprise: transmitting a first positioning signal to a first external electronic device and receiving a first response signal corresponding to the first positioning signal from the first external electronic device; identifying a first separation distance between the electronic device and the first external electronic device and an angle of arrival between the electronic device and the first external electronic device based on the received first response signal; based on the first separation distance being determined to exceed a specified value, transmitting a second positioning signal to a second external electronic device; receiving a second response signal corresponding to the second positioning signal from the second external electronic device; identifying a second separation distance between the first external electronic device and the second external electronic device based on the received second response signal; and determining that the first external electronic device is located within an overlapping region among a first radius region corresponding to the first separation distance, a second radius region corresponding to the second separation distance, and a region corresponding to the angle of arrival.

According to an example embodiment, the transmitting of the first positioning signal to the first external electronic device may comprise transmitting the first positioning signal to the first external electronic device based on an ultra-wideband (UWB) protocol, and the transmitting of the second positioning signal to the second external electronic device may include transmitting the second positioning signal to the second external electronic device based on the ultra-wideband (UWB) protocol.

According to an example embodiment, the receiving of the second response signal corresponding to the second positioning signal from the second external electronic device may include receiving the second response signal corresponding to the second positioning signal from the second external electronic device based on a Bluetooth protocol.

According to an example embodiment, the transmitting of the first positioning signal to the first external electronic device may include transmitting the first positioning signal to the first external electronic device based on receiving a specified input, wherein the specified input may include a touch input to a user interface for providing a function of searching for the location of the first external electronic device.

According to an example embodiment, the method may further comprise displaying, on a display, guide information and information associated with a direction to a region in which the first external electronic device has been determined to be located with respect to the electronic device.

According to an example embodiment, the method may comprise include: identifying, at specified intervals, the separation distance between the electronic device and the first external electronic device based on a UWB protocol; and, based on the identified separation distance being determined to be equal to or less than the specified value, displaying determined location information of the first external electronic device on the display.

According to an example embodiment, the method may further comprise: transmitting a third positioning signal to a third external electronic device and receiving a third response signal corresponding to the third positioning signal from the third external electronic device using the wireless communication circuit; identifying a third separation distance between the first external electronic device and the third external electronic device based on the received third response signal; and determining that the first external electronic device is located within an overlapping region among the first radius region, the second radius region, and a third radius region corresponding to the third separation distance, wherein the third radius region may include a substantially circular region with the third external electronic device as a center and the third separation distance as a radius.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. An electronic device comprising:
a wireless communication circuit;
at least one processor; and
a memory,
wherein the memory stores instructions that, when executed by one or more of the at least one processor, cause the electronic device to:
transmit a first positioning signal to a first external electronic device and receive a first response signal corresponding to the first positioning signal from the first external electronic device using the wireless communication circuit;
identify a first separation distance between the electronic device and the first external electronic device and an angle of arrival between the electronic device and the first external electronic device based on the received first response signal;
transmit, based on the first separation distance being determined to exceed a specified value, a second positioning signal to a second external electronic device and receive a second response signal corresponding to the second positioning signal from the second external electronic device;
identify a second separation distance between the first external electronic device and the second external electronic device based on the received second response signal; and
determine that the first external electronic device is located within an overlapping region among a first radius region corresponding to the first separation distance, a second radius region corresponding to the second separation distance, and a region corresponding to the angle of arrival.

2. The electronic device of claim 1, wherein the second response signal includes information associated with a separation distance between the electronic device and the second external electronic device.

3. The electronic device of claim 1, wherein the instructions, when executed by one or more of the at least one processor, cause the electronic device to:
transmit the first positioning signal to the first external electronic device and transmit the second positioning signal to the second external electronic device based on an ultra-wideband (UWB) protocol.

4. The electronic device of claim 1, wherein the instructions, when executed by one or more of the at least one processor, cause the electronic device to:
receive the second response signal corresponding to the second positioning signal from the second external electronic device based on a Bluetooth protocol.

5. The electronic device of claim 1, wherein the electronic device, the first external electronic device, and the second external electronic device belong to a same account or a same group.

6. The electronic device of claim 1, wherein the first radius region includes a substantially circular region with the electronic device as a center and the first separation distance as a radius, and the second radius region includes a substantially circular region with the second external electronic device as a center and the second separation distance as a radius.

7. The electronic device of claim 1, wherein the instructions, when executed by one or more of the at least one processor, cause the electronic device to:
transmit the first positioning signal to the first external electronic device based on receiving a specified input,
wherein the specified input includes a touch input to a user interface for providing a function of searching for the location of the first external electronic device.

8. The electronic device of claim 1, wherein the electronic device further includes a display,
and the instructions, when executed by one or more of the at least one processor, cause the electronic device to:
display, on the display, guide information and information associated with a direction to a region in which the first external electronic device has been determined to be located with respect to the electronic device.

9. The electronic device of claim 1, wherein the instructions, when executed by one or more of the at least one processor, cause the electronic device to:
identify, at specified intervals, the separation distance between the electronic device and the first external electronic device based on a UWB protocol, and,
display, based on the identified separation distance being determined to be equal to or less than the specified value, determined location information of the first external electronic device on the display.

10. The electronic device of claim 1, wherein the instructions, when executed by one or more of the at least one processor, cause the electronic device to:
transmit a third positioning signal to a third external electronic device and receive a third response signal corresponding to the third positioning signal from the third external electronic device using the wireless communication circuit,
identify a third separation distance between the first external electronic device and the third external electronic device based on the received third response signal, and
determine that the first external electronic device is located within an overlapping region among the first radius region, the second radius region, and a third radius region corresponding to the third separation distance,
wherein the third radius region includes a substantially circular region with the third external electronic device as a center and the third separation distance as a radius.

11. A method for operating an electronic device to perform a positioning operation, the method comprising:
transmitting a first positioning signal to a first external electronic device and receiving a first response signal corresponding to the first positioning signal from the first external electronic device;
identifying a first separation distance between the electronic device and the first external electronic device and an angle of arrival between the electronic device and the first external electronic device based on the received first response signal;
based on the first separation distance being determined to exceed a specified value, transmitting a second positioning signal to a second external electronic device;
receiving a second response signal corresponding to the second positioning signal from the second external electronic device;
identifying a second separation distance between the first external electronic device and the second external electronic device based on the received second response signal; and
determining that the first external electronic device is located within an overlapping region among a first radius region corresponding to the first separation distance, a second radius region corresponding to the second separation distance, and a region corresponding to the angle of arrival.

12. The method of claim 11, wherein the second response signal includes information associated with a separation distance between the electronic device and the second external electronic device.

13. The method of claim 11,
wherein the transmitting of the first positioning signal to the first external electronic device includes transmitting the first positioning signal to the first external electronic device based on an ultra-wideband (UWB) protocol, and
the transmitting of the second positioning signal to the second external electronic device includes transmitting the second positioning signal to the second external electronic device based on the ultra-wideband (UWB) protocol.

14. The method of claim 11, wherein the receiving of the second response signal corresponding to the second positioning signal from the second external electronic device includes receiving the second response signal corresponding to the second positioning signal from the second external electronic device based on a Bluetooth protocol.

15. The method of claim 11, wherein the electronic device, the first external electronic device, and the second external electronic device belong to a same account or a same group.

16. The method of claim 11, wherein the first radius region comprises a substantially circular region with the electronic device as a center and the first separation distance as a radius, and the second radius region comprises a substantially circular region with the second external electronic device as a center and the second separation distance as a radius.

17. The method of claim 11,
wherein the transmitting of the first positioning signal to the first external electronic device comprises transmitting the first positioning signal to the first external electronic device based on receiving a specified input,
wherein the specified input includes a touch input to a user interface for providing a function of searching for the location of the first external electronic device.

18. The method of claim 11, wherein the method further comprises:
displaying, on a display, guide information and information associated with a direction to a region in which the first external electronic device has been determined to be located with respect to the electronic device.

19. The method of claim 11, wherein the method further comprises:
identifying, at specified intervals, the separation distance between the electronic device and the first external electronic device based on a UWB protocol, and
displaying, based on the identified separation distance being determined to be equal to or less than the specified value, determined location information of the first external electronic device on the display.

20. The method of claim 11, wherein the method further comprises:
transmitting a third positioning signal to a third external electronic device and receive a third response signal corresponding to the third positioning signal from the third external electronic device using the wireless communication circuit,
identifying a third separation distance between the first external electronic device and the third external electronic device based on the received third response signal, and
determining that the first external electronic device is located within an overlapping region among the first radius region, the second radius region, and a third radius region corresponding to the third separation distance,
wherein the third radius region includes a substantially circular region with the third external electronic device as a center and the third separation distance as a radius.
